(19) United States
(12) Patent Application Publication
(10) Pub. No.: US 2003/0072960 A1
(43) Pub. Date: Apr. 17, 2003

(54) Manufacturing process of composite vacuum vapor-deposition material wire and wire manufactured thereby

(75) Inventors: Shinji Furuichi, Mohka (JP); Noritsugu Ogata, Tokyo (JP); Shigetoshi Takashima, Sakado (JP)

Correspondence Address: SUGHRUE MION, PLLC, 2100 PENNSYLVANIA AVENUE, N.W., WASHINGTON, DC, 20037, US

(73) Assignee: HITACHI METALS, LTD.

(21) Appl. No.: 10/245,308

(22) Filed: Sep. 18, 2002

(30) Foreign Application Priority Data
Oct. 16, 2001 (JP) 2001-317890

(51) Int. Cl. B32B 15/02

(52) U.S. Cl. 428/607; 428/652; 428/653

(57) ABSTRACT

Disclosed is a process for manufacturing a long composite vacuum vapor-deposition material wire in which an outer periphery of a core wire of iron, nickel, cobalt or an alloy of these metals is coated or sheathed with an aluminum or aluminum alloy. The outer periphery of the core wire is coated or sheathed with aluminum etc. by plastic working, thereby to form a primary composite wire so as not to form a macroscopic space between the core wire and the aluminum coating. By performing a cold wire drawing of this primary composite wire, the core material and the coating material are integrally drawn and firmly bonded together by the self-heat generation or frictional heat during plastic deformation. It is possible to obtain a composite vacuum vapor-deposition material wire which has a weight ratio of core portion of 8 to 45 wt. %, a uniform composition distribution in length and a length of more than 100 m.

### BACKGROUND OF THE INVENTION

1. Field of the Invention

The present invention relates to a composite vapor-deposition material suitable for use in forming composite vapor-deposited films with different film compositions formed in the initial and final stages of evaporation in a continuous vacuum vapor-deposition process. More particularly, the present invention relates to a composite vapor-deposition material suitable for use in forming a composite vapor-deposited film with film compositions greatly varied as found in a light reflecting film and an optical absorption film provided on a phosphor surface in a cathode-ray tube, such as a color television picture tube, and a manufacturing process of the composite vapor-deposition material.

2. Description of the Related Art

The need for forming a plurality of laminated vapor-deposited films having different properties in a continuous vacuum vapor-deposition process arises. In a cathode-ray tube, such as a color television picture tube, for example, phosphors of three colors are applied in a dotted or striped pattern to the inside surface of the faceplate, with a thin-film layer having a high light reflectivity, such as aluminum, formed on the phosphor-coating, that is, the surface opposite to the faceplate, so that the light going toward the inside of the CRT among visible light emitted from the phosphors is reflected by the aluminum thin-film layer to increase the amount of light reaching the front surface of the faceplate. In rear of the phosphor-coated faceplate surface disposed is a shadow mask, or an aperture mask, that acts as color selecting electrodes to control the position on the phosphor faceplate at which each of electron beams from the electron gun can strike only its intended color phosphor dot. These electrodes allow about 20% of the electron beams to pass through the shadow mask to the side of the phosphor-coated surface, while shielding the remaining 80%. The shielded 80% of the electron beams contributes to a temperature rise in the color selecting electrodes. The temperature rise causes heat radiation from the color selecting electrodes, which is concentrated to the closest phosphor-coated surface, with most of the heat reflected by an aluminum mirror backing provided on the phosphor-coated faceplate. Since the reflected heat reaches the color selecting electrodes again, the temperature rise in the electrodes is further facilitated. With the temperature rise, the color selecting electrodes may be deformed due to thermal expansion, leading to misalignment between the color selecting electrodes and the phosphors.

Previous efforts to cope with this have included the application of a carbon coating on the surface of an aluminum film layer provided on the phosphor surface, as disclosed in U.S. Pat. No. 3,703,401 (issued Nov. 21, 1972), so that radiant heat from color selecting electrodes can be absorbed by the heat absorbing effect of the carbon coating. Carbon coating, however, has to be sprayed after dissolved in a solvent, such as an organic solvent. Moreover, this spray coating must be carried out separately from the process of vacuum vapor-deposition of aluminum onto the phosphor surface. This makes the process complex and troublesome, and continuous operation impossible.

When carbon or chromium, both having a radiant-heat absorbing property, is vacuum vapor-deposited together with aluminum having a high light reflectivity, a composite vapor-deposited film having an aluminum-rich composition formed in the initial stage of the vapor-deposition and a carbon- or chromium-rich composition formed in the final stage can be expected due to a difference in vapor pressure between aluminum and carbon or chromium. The aluminum-rich composition formed in the initial stage, however, has a low light reflectivity due to the high content of carbon or chromium. The carbon- or chromium-rich composition formed in the final stage, on the other hand, contains a large amount of aluminum, leading to a meager level of radiant-heat absorption.

To cope with this, a vapor-deposited film having a double-layer construction consisting of entirely different compositions can be obtained by first forming a vapor-deposited film by placing an aluminum block as an initial vapor-deposition material on an evaporation tray, and then continuing evaporation by placing an vapor-deposition material, such as carbon or chromium, that is different from the initial vapor-deposition material on the evaporation tray. This, however, involves two separate vapor-deposition procedures.

Metals of iron group, such as iron, nickel and cobalt, or their alloys have recently begun to be used in place of carbon and chromium as a radiant-heat absorbing film of a CRT. However, the same problem as described above arose also in the formation of composite vapor-deposited films of aluminum and these metals of iron group.

To cope with this, several persons among the present inventors proposed in the U.S. Pat. No. 6,372,362 (issued Apr. 16, 2002) a composite vapor-deposition material having a mixture of low-vapor-pressure metal powder and aluminum in the inside core portion of an aluminum envelope. By using the proposed composite vapor-deposition material, it is possible to form a composite vapor-deposited film in which an aluminum layer and a layer of a metal of iron group are separately laminated.

In an automatic vapor-deposition device in CRT production, it is required that a composite vapor-deposition material wire be automatically fed to the vapor-deposition device. In order to supply a composite vapor-deposition material wire wound on a spool, it is necessary to use a long composite vapor-deposition material wire. In the above proposed composite vapor-deposition material, however, it is impossible to obtain a long wire.

In order to fabricate a wire by coating with aluminum the outer periphery of a core, which is a wire made of iron, nickel, cobalt or an alloy of these metals, a wire of a metal of iron group was inserted in a through hole of an aluminum sleeve and the sleeve and the wire were then drawn together. However, there is a gap between the aluminum sleeve and the wire, and wire drawing could not be satisfactorily carried out because slip occurred between the two. A core wire broke during wire drawing or the longitudinal composition did not become uniform because of the nonuniform thickness of the core wire and aluminum sleeve. Also, air was captured between a core wire and an aluminum sleeve and became blisters by heating during vapor-deposition, with the result that a burst of a composite vapor-deposited wire occurred.

### SUMMARY OF THE INVENTION

Therefore, an object of the invention is to provide a process for manufacturing a very long composite vacuum vapor-deposition material wire in which a core wire of iron, nickel, cobalt or an alloy of these metals is coated or sheathed with aluminum or an aluminum alloy.

Another object of the invention is to provide a composite vacuum vapor-deposition material wire capable of being automatically fed to a vapor-deposition device.

A process for manufacturing a composite vacuum vapor-deposition material wire according to the invention comprises the steps of coating or sheathing the outer periphery of a core wire of Fe, Ni, Co or an alloy of these metals with an aluminum or aluminum alloy layer by plastic working, thereby to fabricate a composite wire so as not to form a macroscopic gap between the above-described core wire and the above-described aluminum sheath layer; and performing cold wire drawing of the above-described composite wire, thereby to ensure the pressure-molten metal bonding of the aluminum or aluminum alloy layer to the outer periphery of the core wire. It is preferred that the aluminum or aluminum alloy used in the invention have a purity of more than 99.7 wt. % or more than 99.99 wt. %.

It is preferred that the overall reduction of area by the above-described cold wire drawing be 40 to 97%. A composite vacuum vapor-deposition material wire which contains 8 to 45 wt. % Fe, Ni, Co or an alloy of these metals, and has an outside diameter of less than 3 mm, a length of more than 100 m and a tensile strength of more than 150 N/mm² is manufactured by the above-described manufacturing process.

In a composite vapor-deposition material wire according to the invention, the outer periphery of a core wire of Fe, Ni, Co or an alloy of these metals is sheathed with aluminum layer by pressure-molten metal bonding, and the composite vapor-deposition material wire contains 8 to 45 wt. % Fe, Ni, Co or an alloy of these metals and has an outside diameter of less than 3 mm, a length of more than 100 m and a tensile strength of more than 150 N/mm².

In the invention, the outer periphery of a core wire of Fe, Ni, Co or an alloy of these metals is coated or sheathed with aluminum or an aluminum alloy by plastic working so as not to form a macroscopic gap between the core wire and the aluminum coating or an envelope. Even when there is no bond between the core and the coating, it is necessary only that an apparent gap be not formed. If there is an apparent gap on cold wire drawing, which is the succeeding step, the core and the outer layer are not integrally drawn. Therefore, if there is a gap, it is necessary only that the gap be of such an extent that the core and the outer layer can be integrally drawn.

In the cold wire drawing of a primary composite wire, which is fabricated by coating or sheathing the outer periphery of a wire of iron, nickel, cobalt or an alloy of these metals with aluminum or an aluminum alloy by plastic working, the metal(s)/alloy(s) on the core surface and the inner surface of the envelope are bonded together. By setting the overall reduction of area by cold wire drawing at 40 to 97%, firm bolding occurs due to the self-heat generation or frictional heat when the core material and the coating material are integrally drawn and plastically deformed. The overall reduction of area is defined as a ratio of a change in area between a sectional area S0 before cold working and a sectional area S after performing cold wire drawing several times or tens of times, and expressed by (S0−S)/S0×100 (%).

It is preferred that the reduction of area by one step of the cold wire drawing be 15 to 30%. In order to prevent a break of the core metal, it is important that the overall reduction of area be less than 97%. From various studies, it has been apparent that a break of the core metal does not occur when the reduction of area is 97.8 to 98.3% or less. However, if the core metal breaks, the composition near the broken portion becomes nonuniform. Therefore, conservatively, it is preferred that the reduction of area be less than 97%. The coating metal and the core metal are firmly bonded with an overall reduction of area of more than 40% and even when the material wire is bent, a phenomenon such as an exfoliation of an aluminum-base metal from the core metal does not occur.

It is important for the invention that the coating metal and the core metal are firmly bonded together by cold working. Because the coating metal and the core metal are firmly bonded together, the coating metal and the core metal elongate integrally when they are subjected to further cold working, with the result that it is possible to obtain a composite vapor-deposition material wire of the invention which is very long and has a uniform composition distribution in length. Furthermore, it is possible to prevent blisters which might cause a burst from being formed by heating during vacuum vapor-deposition when air is captured between the coating metal and core metal of a composite vapor-deposition material wire.

It is difficult to digitize the bonding strength of the coating metal and the core metal. However, as a rough standard, it can be judged by the following two methods that a bonding strength necessary for a vapor-deposition material exists. In one method, after a vapor-deposition material wire is pinched by a vise etc. and the outside diameter is crushed 10% or so, the section of the crushed portion is observed and it is ensured that there is no gap in the bonded boundary between the aluminum coating metal and the core metal. In the other method, it is ascertained that the surface roughness of the core metal which appears in the composite wire section after cold wire drawing is rougher than the surface roughness of the core metal before cold wire drawing.

This bonding between the coating metal and the core metal can be called pressure-molten metal bonding. In pressure-molten metal bonding, metals are not bonded together by being molten; instead, metals soften by the self-heat generation during plastic deformation and are bonded together by a force applied from the outside. That is, the bonding portion is not bonded by raising the temperature of the bonding portion to a melting temperature; instead, the bonding portion is bonded by softening metals by plastic deformation. In pressure-molten metal bonding, the temperature is not raised until a molten state is obtained and, therefore, metallic materials used do not evaporate or oxidize remarkably.

The weight ratio of the core metal in the whole composite vapor-deposition material wire is more than 8% but less than 45%. The weight ratio of the core metal is preferably not more than 33%. When used in a CRT, the whole composite vapor-deposition material wire cannot obtain performance as a heat radiation film if the weight ratio of the core metal is not more than 8%. However, at a weight ratio of the core metal of more than 33%, the ratio of electrons which permeate the vapor-deposited film decreases and a decrease in luminance becomes not negligible. However, when composite vapor-deposition material wire is used together with another vapor-deposition material wire or after another vapor-deposition material wire, a weight ratio of the core metal of up to 45% is allowed. In terms of heat radiation characteristics and luminance characteristics, it is more preferred that the weight ratio of the core metal be more than 10% but less than 30%.

In order to place a vapor-deposition material on an evaporation tray in a stable manner, it is preferred that the diameter of the vapor-deposition material be not more than 3 mm and that the length be more than twice the diameter. A vapor-deposition material wire wound on a spool is attached to a vapor-deposition device, automatically cut to a required length and supplied to the evaporation tray. In supplying the vapor-deposition material wire wound on the spool to the vapor-deposition device, the requirement that the length of the vapor-deposition material wire should be more than 100 m is important in terms of work efficiency. In order to lower the spool replacement frequency, the length of the vapor-deposition material wire should be 100 m at the minimum. When the length is preferably more than 200 m, it is necessary only that the spool be replaced once or so a day.

The vapor-deposition material wire is cut to a prescribed length and supplied to the evaporation tray of the vapor-deposition device. In cutting the vapor-deposition material wire, the wound wire is set on a straightener to correct winding defects and then cut. Because a tensile force acts on the vapor-deposition material wire in these steps, it is important that the wire be not broken when stretched and that the wire be not elongated accidentally. Therefore, it is necessary that the vapor-deposition material wire have a tensile strength of more than 150 (N/mm²) in the cutting stage. It is also preferable that elongation be less than several percent.

### BRIEF DESCRIPTION OF THE DRAWINGS

FIG. 1A and FIG. 1B are schematic diagrams of a composite vacuum vapor-deposition material of the invention; and

FIG. 2 is an explanatory diagram of a process for manufacturing a composite vacuum vapor-deposition material wire of the invention.

### DETAILED DESCRIPTION OF THE PREFERRED EMBODIMENTS

### EXAMPLE 1

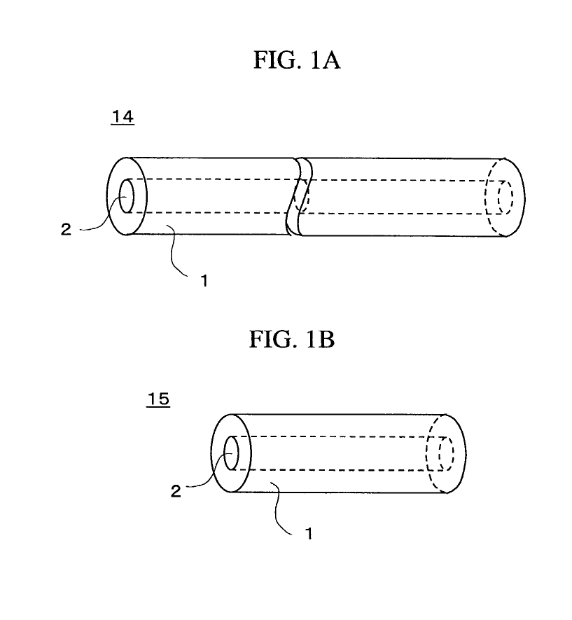

Examples of the invention will be described below in detail by referring to the drawings. FIGS. 1A and 1B are perspective views of a composite vapor-deposition material wire of the invention. FIG. 1A shows a composite vapor-deposition material wire having a prescribed outside diameter, and FIG. 1B shows a vapor-deposition material obtained by cutting a composite vapor-deposition material wire to a prescribed length. A core metal 2 is provided in the core portion of an aluminum envelope 1 of roughly cylindrical shape. The outside diameter of the aluminum envelope 1 is 1.5±0.005 mm and the diameter of the core metal is 0.67±0.01 mm. The composite vapor-deposition material wire of FIG. 1A is 300 m long. The cut vapor-deposition material of FIG. 1B is 20±0.2 mm long. In this example, iron was used as the core metal and with the above-described size and shape, the composition was 42.0 wt. % iron and 58.0 wt. % aluminum.

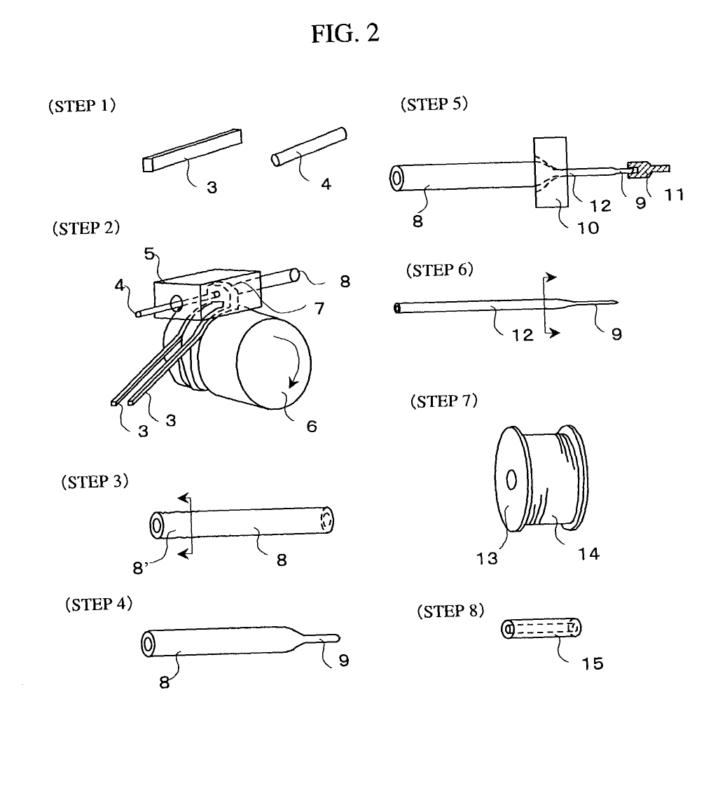

The manufacturing method used in this example will be described by referring to FIG. 2. To make the description easily understandable, the same component parts are given the same reference numerals. A CONFORM extrusion machine was used in fabricating a primary composite wire by coating the outer periphery of an iron wire with aluminum by plastic working so that no macroscopic gap was formed between the iron wire and the aluminum coating layer. The CONFORM extrusion process is a plastic working method developed by the United Kingdom Atomic Energy Authority (UKAEA), by which extrusion is performed by utilizing a frictional force. Because the principle of the CONFORM extrusion process is disclosed in Metals Technology, August 1984, Vol. 11, details are omitted. With the CONFORM extrusion process, it is difficult to fabricate small-diameter products although it is relatively easy to fabricate long products. Because aluminum is applied to the outer periphery of the core while aluminum is being plastically deformed by applying tension to the metal of the core portion, a material having a core metal of 0.8 mm or more is mainly used. Because the aluminum thickness can be reduced, it is possible to fabricate a clad material having a core of 0.8 mm and an outside diameter of 1.5 mm or so. In a clad material fabricated by the CONFORM extrusion process, the bonding strength of aluminum with the metal material of the core portion is weak and, therefore, when clad material is wound on a small-diameter spool, the aluminum and the core portion metal may sometimes exfoliate, forming a microscopic gap of more than several tens of microns. However, there is no macroscopic gap.

In order to fabricate a primary composite wire of a composite vacuum vapor-deposition material, an aluminum wire 3 of 6 mm square and an iron wire 4 with an outside diameter of 1.6 mm were prepared in a length of about 300 m each (STEP 1). The iron wire was beforehand subjected to heat treatment in hydrogen at 700° C. for the removal of surface smudges and for softening treatment. The iron wire 4 was attached to a die box 5 of a CONFORM extrusion machine and the aluminum wire 3 was attached to a wheel 6 of the machine, and by rotating the wheel 6, a primary composite wire 8 in which the iron wire 4 is coated or sheathed with aluminum by a coating portion 7 was obtained (STEP 2). Because the outlet diameter of the coating portion 7 was 5 mm, the outside diameter of the primary composite wire 8 became 5 mm. However, the diameter of the iron wire of the core portion scarcely changed. The primary composite wire 8 was obtained by cutting and removing a beginning portion 8′ of the primary composite wire (STEP 3). In order to draw out a leading end portion of the primary composite wire 8 from a wire drawing die, a necked portion 9 was fabricated by tapping the leading end portion (STEP 4). The necked portion 9 was threaded into a wire drawing die 10, the leading end was fixed to a damper 11 of a wire drawing machine, and wire drawing was performed (STEP 5). STEPS 4 and 5 were repeated until a composite vapor-deposition material wire 12 having a diameter of 1.5 mm was obtained. Because the reduction of area per wire drawing operation was set at 15 to 30%, 14 types of wire drawing dies were used. The composite vapor-deposition material wire 12 was obtained by removing the necked portion 9 of the leading end of the composite vapor-deposition material wire 12 (STEP 6). The long composite vapor-deposition material wire 14 (STEP 7) wound on a spool 13 and a vapor-deposition material 15 obtained by cutting this wire 12 to 20±0.2 mm were obtained (STEP 8).

The bonding strength of the aluminum 1 with the core metal 2 in the primary composite wire 8 and the composite vapor-deposition material wire 12 was evaluated. Each sample was pinched by a vise and pressed until the outside diameter became about 95% of the initial outside diameter. After that, the circular section of the pressed portion was polished and observed. Gaps of 20 to 50 μm or so were observed at the boundary between the aluminum and the iron of the primary composite wire. No gap was observed at all at the boundary of the composite vapor-deposition material wire and it was ascertained that a strong bond is obtained. From this, it is apparent that the cold wire drawing step of the composite vapor-deposition material wire not only contributes to a reduction of diameter, but also is effective in firmly bonding the aluminum coating layer and the core metal together. Furthermore, when a section obtained by cutting the composite vapor-deposition material wire by means of a cutting machine was observed, no peeling of the boundary was found.

A composite vapor-deposition material wire having an outside diameter of 1.5 mm was subjected to a tensile test and tensile strength was measured. The tensile strength was about 240 (N/mm²) and the wire was not broken even when it was pulled by a straightening machine or a cutting machine.

For comparison, an iron wire inserted in an aluminum pipe was cold drawn. The aluminum pipe had an outside diameter of 12.5 mm and an inside diameter of 3.5 mm, and the iron wire had a diameter of 3.0 mm. The reason why the difference between the inside diameter of the aluminum pipe and the outside diameter of the iron wire was set at 0.5 mm is to produce a minimum gap which permits easy insertion. The length of the aluminum pipe and the iron wire was 1.5 m each. The iron wire was beforehand subjected to heat treatment in hydrogen at 700° C. The aluminum pipe decreased in outside diameter without a change in wall thickness until the aluminum pipe was bonded to the iron wire. Although wire drawing could be performed until the diameter reached 2.3 mm, a break of the iron began with a diameter of less than 2.3 mm. By performing heat treatment in nitrogen at 550° C. when the diameter became 2.5 mm, wire drawing could be performed until the diameter reached 1.6 mm. However, a break of the iron began with a diameter of less than 1.6 mm and wire drawing to a diameter of 1.5 mm was impossible. A section of the composite vapor-deposition material wire with a diameter of 2.3 mm obtained by wire drawing was polished and the iron content was measured. The iron content was 27 to 32 wt. % and higher than expected. In addition, variations in composition in the longitudinal section were large. It might be thought that this is because in the aluminum pipe, variations in thickness occurred until the aluminum pipe was bonded to the iron wire. Also from this, it is apparent that by fabricating a primary composite wire by CONFORM extrusion as in the present invention and by the cold wire drawing of this primary composite wire to obtain a composite vapor-deposition material wire, not only a uniform composition distribution in length is obtained, but also a long product in which aluminum and iron are firmly bonded together is easily obtained.

### EXAMPLE 2

In order to fabricate a primary composite wire, an aluminum wire 3 of 6 mm square and an iron wire 4 having a diameter of 0.943 mm were prepared in a length of about 300 m each. The iron wire was beforehand subjected to heat treatment in hydrogen at 700° C. for the removal of surface smudges and for softening treatment. A primary composite wire fabricated by performing CONFORM extrusion had an outside diameter of 5 mm, and the outside diameter of the iron wire of 0.943 mm was the same as the outside diameter of the iron wire before CONFORM extrusion. The iron content was about 9.7 wt. %. Cold wire drawing (overall reduction of area: 84%) was performed until the outside diameter became 2.0 mm and a composite vapor-deposition material wire was obtained. The outside diameter of the iron wire in the core portion of the composite vapor-deposition material wire was 0.377 mm and the iron content was about 9.7 wt. %. This iron content was the same as the iron content of the primary composite wire. The tensile strength was about 200 (N/mm²). Incidentally, the length of the composite vapor-deposition material wire obtained at this time was about 1800 m.

For comparison, an iron wire inserted in an aluminum pipe was cold drawn. In consideration of variations in composition, three types of aluminum pipes were prepared with an outside diameter of 10.5 mm×an inside diameter of 2.0 mm, an outside diameter of 10.0 mm×an inside diameter of 1.5 mm, and an outside diameter of 9.5 mm×an inside diameter of 1.5 mm, and also three types of iron wires to be inserted were prepared with outside diameters of 1.5 mm, 1.3 mm and 1.0 mm. The reduction of area of 15 to 30% per wire drawing operation was the same as in the wire drawing of the above-described composite vapor-deposition material wire. However, a break of the iron began with an aluminum outside diameter of 2.7 mm or so and all the three types of iron wires broke with an outside diameter of 2.4 mm, with the result that a wire having an outside diameter of 2.0 mm could not be obtained. When the iron content of samples with diameters immediately before the occurrence of a break was measured, it varied greatly in the range of 10 to 21 wt. %.

### EXAMPLE 3

A primary composite wire having an outside diameter of 5 mm and a nickel core diameter of 1.6 mm was fabricated by CONFORM extrusion and after that by performing cold wire drawing with an overall reduction of area of 84%, a composite vapor-deposition material wire having an outside diameter of 2.0 mm was obtained. The nickel content of the primary composite wire was 27.3 wt. % and the nickel content of the composite vapor-deposition material wire was 27.6 wt. % and showed almost the same value. The length of this composite vapor-deposition material wire was about 1700 m and the tensile strength was 220 N/mm².

For comparison, a nickel wire inserted in an aluminum pipe was cold drawn. The aluminum pipe had an outside diameter of 12.5 mm and an inside diameter of 3.5 mm, and the nickel wire had a diameter of 3.0 mm. An experiment was conducted by using various reductions of area. When the outside diameter became in the range of 2.0 to 2.5 mm, the nickel wire broke and it was impossible to manufacture a composite vapor-deposition material wire having an outside diameter of 2.0 mm in a stable manner. When the nickel content of samples immediately before a break was measured, it was 31.8 wt. % and deviated from an expected value by as high as about 5 points.

### EXAMPLE 4

A primary composite wire in which the outside diameter of an aluminum coating is 5 mm and the core metal is cobalt (diameter: 1.6 mm) was fabricated by CONFORM extrusion and by performing cold wire drawing with an overall reduction of area of 87% after that, a 2000 m long composite vapor-deposition material wire having an outside diameter of 1.8 mm was obtained. The nickel content of the primary composite wire was 27.2 wt. % and the cobalt content of the composite vapor-deposition material wire was 27.4 wt. % and showed almost the same value. Incidentally, the tensile strength was 200 N/mm².

For comparison, a cobalt wire inserted in an aluminum pipe was cold drawn. The aluminum pipe had an outside diameter of 12.5 mm and an inside diameter of 3.5 mm, and the cobalt wire had a diameter of 3.0 mm. An experiment was conducted by using various reductions of area. When the outside diameter became in the range of 2.5 to 2.9 mm, the cobalt wire broke and it was impossible to manufacture a composite vapor-deposition material wire having an outside diameter of 1.8 mm. When the cobalt content of samples with diameters immediately before a break was measured, it was 34.3 wt. % and deviated from an designed value by as high as about 7 points.

As described above, the core portion is fabricated from a metal selected from the group consisting of nickel, iron and cobalt or an alloy of these metals, the outer periphery of this core metal is coated or sheathed with aluminum by plastic working to fabricate a primary composite wire, and this primary composite wire is cold drawn to obtain a composite vapor-deposition material wire. Therefore, the weight ratio of the core portion is 8 to 45 wt. % of the whole and the composition is stable. A long composite vacuum vapor-deposition material wire which has an outside diameter of less than 3 mm and a length of more than 100 m, and in which the aluminum coating and the metal of the core portion are firmly bonded together can be supplied with a good yield and at a low cost.

What is claimed is:

1. A process for manufacturing a composite vacuum vapor-deposition material wire, comprising the steps of:
coating an outer periphery of a core wire of Fe, Ni, Co or an alloy of these metals with an aluminum or aluminum alloy layer by plastic working, thereby to fabricate a composite wire so as not to form a macroscopic gap between the core wire and the aluminum layer; and
performing cold wire drawing of the composite wire, thereby to ensure a pressure-molten metal bonding of the aluminum or aluminum alloy layer to the outer periphery of the core wire.

2. A process for manufacturing a composite vacuum vapor-deposition material wire according to claim 1, wherein the reduction of area by the cold wire drawing is 40 to 97%.

3. A process for manufacturing a composite vacuum vapor-deposition material wire according to claim 2, wherein the composite vacuum vapor-deposition material wire contains 8 to 45 wt. % Fe, Ni, Co or an alloy of these metals, and has an outside diameter of less than 3 mm, a length of more than 100 m and a tensile strength of more than 150 N/mm².

4. A composite vacuum vapor-deposition material wire in which an outer periphery of a core wire of Fe, Ni, Co or an alloy of these metals is coated with an aluminum or aluminum alloy layer of pressure-molten metal bonding, and which contains 8 to 45 wt. % Fe, Ni, Co or an alloy of these metals and has an outside diameter of less than 3 mm, a length of more than 100 m and a tensile strength of more than 150 N/mm².
